(19) United States
(12) Patent Application Publication
(10) Pub. No.: US 2014/0044336 A1
(43) Pub. Date: Feb. 13, 2014

(54) METHOD AND APPARATUS FOR DISPLAYING RADIOLOGICAL IMAGES

(71) Applicant: General Electric Company, Schenectady, NY (US)

(72) Inventors: Peter Heinlein, Meunchen (DE); Jose Abellan-Martinez, Muenchen (DE); Johan van Breda, Muenchen (DE)

(73) Assignee: General Electric Company, Schenectady, NY (US)

(21) Appl. No.: 13/961,196

(22) Filed: Aug. 7, 2013

(30) Foreign Application Priority Data
Aug. 7, 2012 (DE) 102012213981.8

(51) Int. Cl. G06T 7/00

(52) U.S. Cl. CPC G06T 7/0012
USPC 382/132

(57) ABSTRACT

A method for viewing radiological images, comprising providing a first radiological image, providing a second radiological image co-registered with the first radiological image, computing at least one intermediate image as an interpolation of the first radiological image and the second radiological image, and displaying a sequence of images comprising the first radiological image, the at least one intermediate image, and the second radiological image to a user.

### BACKGROUND OF THE INVENTION

Embodiments of the present invention relate to a method for viewing radiological images and an image processing apparatus for viewing radiological images.

In digital mammography, radiological images in the shape of mammograms are recorded using an X-Ray imaging apparatus. Herein, typically, for diagnosing such images by a physician multiple images are displayed on a display unit such that the physician can compare for example current images with images of a prior examination or can view images of a left and a right breast for the purpose of a symmetry comparison.

A comparison of radiological images on a screen of a display unit requires a rather large screen because multiple images must be shown side by side on the screen. If images are shown side by side on a screen, it in addition may be hard for a physician to visually establish corresponding locations within images such that a diagnosing may be cumbersome and requires a high concentration of the physician.

Within imaging concepts in the field of digital mammography multiple radiological images are recorded and provided to a user to facilitate the identification of lesions or micro-calcifications or other diagnostic findings. For example, within the so called contrast-enhanced spectral mammography (in short: “CESM”), in conjunction with a mammography examination different radiological images using a high-energy and a low-energy imaging are obtained. By for example subtracting such images a recombined image is obtained in which the visualization of lesions is enhanced while other structures such as normal tissue are suppressed. Such a technique is for example described in a an article by C. Dromain et al. entitled “Contrast-Enhanced Digital Mammography” (European Journal of Radiology, vol. 69, issue 1, pages 34-42, January 2009).

In another technique referred to as digital breast tomosynthesis (in short: “DBT”) a three-dimensional imaging volume is imaged obtaining radiological images corresponding to slabs of the three-dimensional volume. DBT uses a low dose short X-Ray sweep around a compressed breast. The acquired projection images are processed electronically in order to reconstruct a three-dimensional representation of the entire breast.

Within the CESM technique and the DBT technique radiological images are generally co-registered. Co-registered images are aligned with each other in that such images use the same coordinate system. Within CESM and DBT generally co-registration is achieved simply because the radiological images are obtained within a single examination procedure of the same breast located at the same position.

If radiological images are not (yet) co-registered, a co-registration may be achieved for example by an intensity-based or a feature-based image registration procedure providing a spatial transformation of a target image to align it with a reference image. Such techniques are well-known and shall not be described in detail within the instant text.

If in the following it is referred to “co-registered images” it is assumed that such images are provided in a co-registered manner by the type of examination procedure or by an image registration after acquisition of the radiological images.

In order to diagnose images showing an object but having different image characteristics (due to the imaging technique or due to the image processing) or in order to examine images corresponding to different slabs of a three-dimensional volume a correspondence of structures and locations in different images must be identified. Because this possibly is not easy when comparing images arranged side by side on a screen of a display unit, there is a need for tools that allow an easy comparison and diagnosis of different images while at the same time being easy to handle and intuitive to use for a physician.

U.S. Pat. No. 7,532,770 discloses a method for combining two or more images by applying image registration and fusion of images. The outcome is a single image comprising features of the original images.

A technique known as image blending is known for example from U.S. Pat. No. 8,019,177 and US 2006/133694 A1 relating to general image processing schemes generating combined images from two or more original images.

US 2009/0228834 A1 discloses a method for viewing images of a number of medical examinations in a film-like sequence in which images are sequentially shown to a user starting from the oldest image and ending at the most current image.

### BRIEF SUMMARY OF THE INVENTION

Embodiments of the present invention provide a method and an image processing apparatus for viewing radiological images allowing for an easy, intuitive and efficient, yet reliable diagnosis by a physician.

According to an embodiment of the present invention, there is provided a method. In the method, a first radiological image and a second radiological image are provided, wherein the second radiological image is co-registered with the first radiological image.

Accordingly, within the method at least one intermediate image is computed as an interpolation of the first radiological image and the second radiological image and a sequence of images is displayed comprising the first radiological image, the at least one intermediate image and the second radiological image.

According to an embodiment, the method provides a cross-fading effect for viewing two or more radiological images. The radiological images herein show the same object in a co-registered manner, but comprise different information in that for example in the one radiological image tissue is suppressed and potential lesions or micro-calcifications are enhanced compared to the other image. In order to allow a physician to associate the information contained in the one radiological image with the information contained in the other radiological image, a cross-fading sequence of images fading from the one image to the other image is generated and presented to a physician in a temporally sequential manner such that the physician can easily make out a spatial correspondence of features in the different radiological images.

For generating and providing the sequence of images a series of intermediate images is generated, wherein each intermediate image is determined as an interpolation between the first radiological image and the second radiological image. The number of intermediate images may vary and can be chosen dependent on for example a desired smoothness in the fading transition from the one radiological image to the other radiological image.

The different radiological images may result from a so-called contrast-enhanced spectral mammography (CESM) examination in which a contrast agent is injected into a patient and different images, for example differing in the spectral energy, are taken. For example, in such an examination a low-energy image and a high-energy image are taken, wherein by subtractive combination of the two images certain features such as tissue can be suppressed while at the same time enhancing other features such as lesions. In this regard, the first radiological image may correspond to a recombined contrast-enhanced spectral mammography image, whereas the second radiological image may correspond to a low-energy contrast-enhanced spectral mammography image. Applying the present invention, a cross-fading type of sequence can be generated to provide a fading effect from one radiological image to the other such that features in the two images can easily be spatially associated with each other.

The radiological images may alternatively correspond to different slabs of a three-dimensional imaging volume imaged using the so called digital breast tomosynthesis (DBT). The first radiological image herein may correspond to a first slab of the three-dimensional imaging volume, whereas the second radiological image may correspond to an adjacent slab such that a cross-fading effect from the one slab to the other slab is provided by applying the method according to an embodiment. In this way, features in the one slab may be associated with features in another slab such that a spatial correspondence can be identified.

The different radiological images may also result from the recordation of a single mammogram which is processed using different image processing techniques. By means of such image processing techniques different features contained in the mammogram can be visualized in different ways, wherein by means of the generation of the sequence of images a cross-fading between such differently processed images is provided allowing for an easy association of such images.

The intermediate images between the first radiological image and the second radiological image are determined as interpolations between the first radiological image and the second radiological image. Each interpolation herein may be a linear combination of the first radiological image and the second radiological image, hence, providing a linear transition from the first radiological image to the second radiological image and vice versa. By means of the sequence of intermediate images the one radiological image is sequentially faded in while the other one fades out such that a transition from one image to the other is provided.

For computing the interpolation a continuous transitional function may be used. Such transitional function may be computed as a progressing transition solely depending on the number of the intermediate image in between the first radiological image and the second radiological image. The transitional function however may also take further parameters into account such as a local intensity or specific contents of the radiological images such that a content dependent transition is provided.

In particular the interpolation may be computed based on specific regions or structures contained in at least one of the first radiological image and the second radiological image such that a fading effect is achieved only within a specific region or for a specific structure. Or the interpolation may be computed based on a local intensity value of at least one of the first radiological image and the second radiological image such that the interpolation depends on the image intensity at the respective pixel locations.

In principle, two approaches of computing the series of intermediate images are possible. First, the intermediate images can be computed on the fly upon a specific viewing request of a user. Hence, when a user selects to view a cross-fading from one radiological image to another the series of images is computed on the fly and the cross-fading sequence is shown to the user. The intermediate images may then be stored for a repeated viewing of the cross-fading sequence, or the intermediate images may not be stored requiring for a repeated computation if the cross-fading sequence shall be viewed again. Second, the intermediate images could be pre-computed in a pre-processing step and stored in memory such that the complete sequence of images is available already upon request by a user. With this approach the computational burden is shifted to a pre-processing step hence reducing the computational load upon a viewing request by a user.

The intermediate images serve to provide a cross-fading sequence generating a cinematic transition from one radiological image to the other. In principle, a transition between more than two radiological images can be provided, wherein a first sequence of images providing a transition from a first radiological image to a second radiological image may be concatenated with a second sequence of images providing a transition from the second radiological image to a third radiological image and so on. In this way, multiple sequences of images can be combined by concatenation, hence providing a cinematic transition between multiple radiological images, for example multiple slabs of a three-dimensional imaging volume.

The viewing of the sequence of images, in an embodiment, is controlled by a toolbar displayed on the screen of a display unit. Via the toolbar, a user can select to view a transitional sequence of images relating to two particular co-registered radiological images, wherein within a particular embodiment the toolbar is displayed to a user only if a particular type of image is available for displaying on the screen. For example, within CESM technique a toolbar may be displayed only if both a low-energy image and a recombined image are available. If, for example no recombined image is available, no toolbar is presented to the user such that the option of viewing a cross-fading sequence of images is not available to the user. Furthermore, the toolbar may not be presented to a user if images are not co-registered such that a transitional cross-fading is available only for co-registered images. In general, it is advantageous if the toolbar is displayed to a user only if the generation and viewing of a sequence of images may be meaningful. Otherwise, it is not offered to a user.

Furthermore, a toolbar may allow a user to adjust the speed of the displaying of the sequence of images, or may provide buttons to forward, backward and/or stop during the displaying of the sequence of images.

The object is further achieved by an image processing apparatus for viewing radiological images comprising a processing unit and a display unit. Herein, the processing unit is configured to compute at least one intermediate image as an interpolation of a first radiological image and a second radiological image being co-registered with the first radiological image, and the display unit is configured to display a sequence of images comprising the first radiological image, the at least one intermediate image and the second radiological image.

The advantages and advantageous embodiments described above for the method are analogously applicable also to the denoted image processing apparatus.

### BRIEF DESCRIPTION OF THE DRAWINGS

The present invention shall subsequently be described in more detail with regard to the embodiments shown in the Figures. Herein,

FIG. 1 shows a schematic drawing of an arrangement of an imaging apparatus in conjunction with an image processing apparatus according to an embodiment of the present invention;

FIG. 2 shows different radiological images showing the same object and being co-registered according to an embodiment of the present invention;

FIG. 3 shows a schematic view of a sequence comprising a first radiological image, a series of intermediate images formed as interpolations between the first radiological image and a second radiological image, and the second radiological image according to an embodiment of the present invention;

FIG. 4 shows a schematic view of a three-dimensional imaging volume according to an embodiment of the present invention; and

FIG. 5 shows a schematic view of a sequence of images comprising a first radiological image corresponding to a first slab of the three-dimensional imaging volume, a series of intermediate images and a second radiological image corresponding to a second slab of the three-dimensional volume according to an embodiment of the present invention.

### DETAILED DESCRIPTION OF THE INVENTION

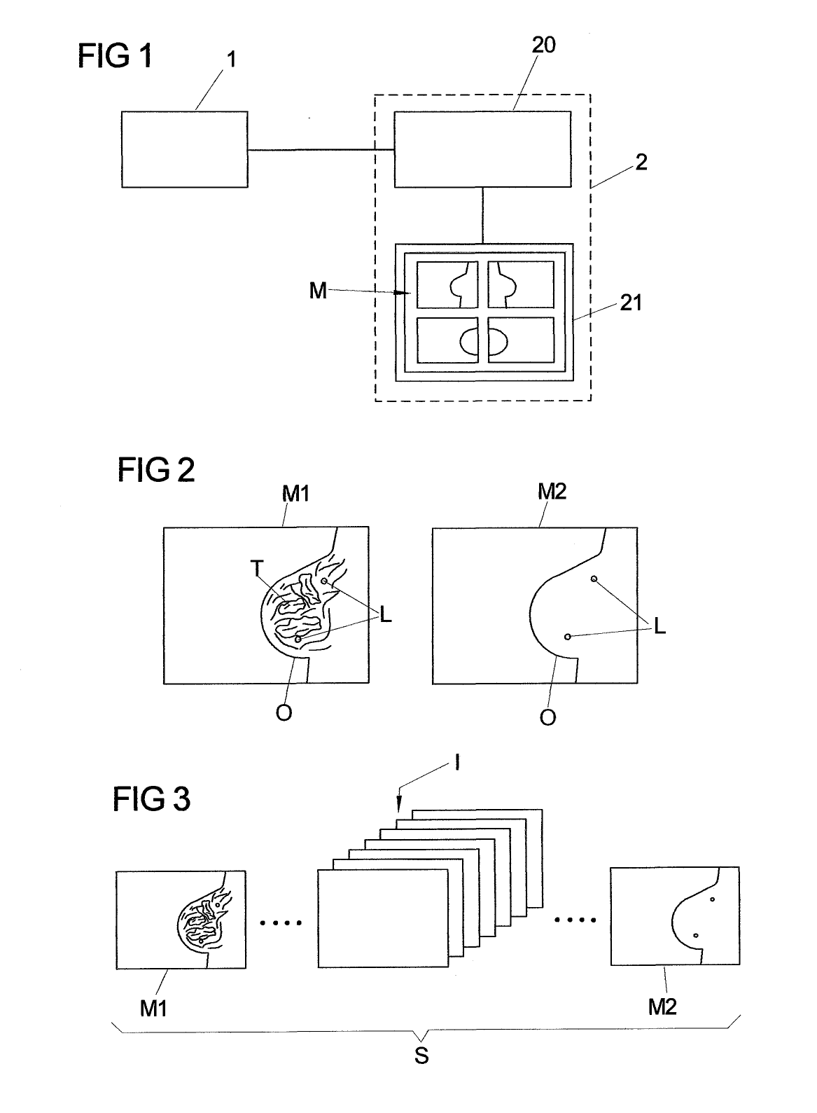

FIG. 1 shows in a schematic view an arrangement for conducting a mammography examination. Herein, an X-Ray imaging apparatus 1 is connected to an image processing apparatus 2 comprising a processing unit 20 and a display unit 21. By means of the imaging apparatus 1 X-Ray images of a female breast are recorded and provided to the processing unit 20 for image processing of the images. The processed images—in this text referred to as radiological images M—are then displayed on the display unit 21 for diagnosis by a physician.

Schematic radiological images M1, M2 are shown in FIG. 2. The radiological images M1, M2 image an object O formed by a female breast and comprising structural information arising for example from tissue T and lesions L or micro calcifications or other peculiar structures.

The radiological images M1, M2 may be obtained using different techniques.

For example, the radiological images M1, M2 may be recorded applying a technique referred to as contrast-enhanced spectral mammography (CESM), in the context of which a contrast agent is injected into a patient, and after a waiting time of 2 to 5 minutes mammograms with a low and high energy spectrum are recorded. Such low-energy and high-energy radiological images may be combined to suppress certain features such as tissue T and enhance other features such as lesions L obtaining a recombined image. As a result, for example a standard mammogram obtained by standard mammography and the recombined image or a low-energy image and the recombined image may be presented to a physician for comparative diagnosis.

Dependent on the type of image, different structures are visualized differently in the radiological images M1, M2. The images, however, are taken in the same examination without moving the imaging apparatus such that the images M1, M2 within the CESM technique generally per se are co-registered, i.e. they use the same coordinate system and show identical structures at the same location.

In order to facilitate a comparative diagnosis of the different radiological images M1, M2 and in order to be able to easily associate locations in the one radiological image M1, M2 with locations in the other radiological image M2, M1, a cross-fading between the radiological images M1, M2 is provided in that a series of intermediate images I—as schematically shown in FIG. 3—is computed as interpolations between the two radiological images M1, M2, thus obtaining a sequence of images S comprising the first radiological image M1 as a start point and the second radiological image M2 as an end point and the series of intermediate images I providing a cinematic cross-fading type of transition from the first radiological image M1 to the second radiological image M2 and vice versa.

The intermediate images I are formed as interpolations between the first radiological image M1 and the second radiological image M2. The interpolations herein may be determined as linear combinations of the first radiological image M1 and the second radiological image M2 according to the general formula:

Iᵢ=(1−tᵢ)A+tᵢ*B,

wherein Iᵢ is the i^{th} intermediate image, tᵢ is a running variable running from 0 to 1, A corresponds to the first radiological image M1 and B corresponds to the second radiological image M2. The running variable tᵢ may be any linear or non-linear continuous monotonous function α(x) with α(0)=0 and α(I)=1.

In this regard it shall be noted that the function α may be any continuous monotonous function defining the running variable tᵢ ranging between 0 and 1. In this regard it is possible that the function α depends on further parameters such as pixel-wise intensity values (gray scale values) of one or both radiological images M1, M2. For example, if the function α is dependent on the intensity value at the different pixels of the co-registered radiological images M1, M2, a fading effect at a specific pixel location may depend on the index number of the intermediate image and in addition on the local image intensity of one or both radiological images such that dependent on the local image intensity different fading speeds for different pixels arise.

The local intensity value may influence the function α in a continuous fashion. It also is possible, however, to define a threshold value for the local intensity such that for example fading does not take place if the local intensity is below the threshold value, but does take place if the local intensity exceeds the threshold value. In this way a fading of specific regions and/or structures of interest may be obtained.

The function α alternatively or additionally may also depend on other parameters, such as pixel location or the like.

In this way the function α may be tailored to blend in specific details or regions of one radiological image M1, M2 into the other, for instance on the basis of a threshold or areas of interest found by means of a CAD tool. This could in the latter case also apply to a single image where a highlighting by means of so called spotlight techniques is faded in or out in a specific region.

By determining a series of intermediate images I as interpolations between the radiological images M1, M2, a sequence of images S is generated which may be viewed in a cinematic manner providing a cross-fading transition from the one radiological image M1, M2 to the other radiological image M2, M1 and vice versa. By means of the sequence of images S viewed in a sequential manner on a screen of the display unit 21 structures of an object O depicted in different radiological images M1, M2 are set in relation to each other such that a physician intuitively can grasp structural correspondences in different radiological images M1, M2.

The number of intermediate images I may be chosen dependent on the desired smoothness of the transition between the different radiological images M1, M2. The number of intermediate images I may range from 1 to any desired number larger than 1 such as 5, 10, 15 or 20 or more intermediate images.

The intermediate images I may be computed on the fly when a user requests to view a transitional sequence of images S fading from one radiological image M1, M2 to another. It however is also possible to pre-compute the intermediate images I in a pre-processing step such that the intermediate images I are available already when the radiological images M1, M2 are displayed to a user.

The cross-fading between radiological images M1, M2 may be available only for certain types of images or in certain situations. For example, if only a low-energy image originating from a contrast-enhanced spectral mammography (CESM) examination is available, but no recombined image, a toolbar offering to display a transitional sequence of images fading from one radiological image M1, M2 to another may not be displayed such that a user cannot select a corresponding viewing option. Only if both a low-energy image and a recombined image are available, the toolbar is displayed to a user such that only in that situation a user can select to view a cross-fading sequence fading from radiological image M1, M2 to the other.

The generation of a cross-fading type of sequence is not only possible for radiological images M1, M2 of a contrast-enhanced spectral mammography examination, but can also be applied to provide a cross-fading between other radiological images M1, M2 resulting from other examinations.

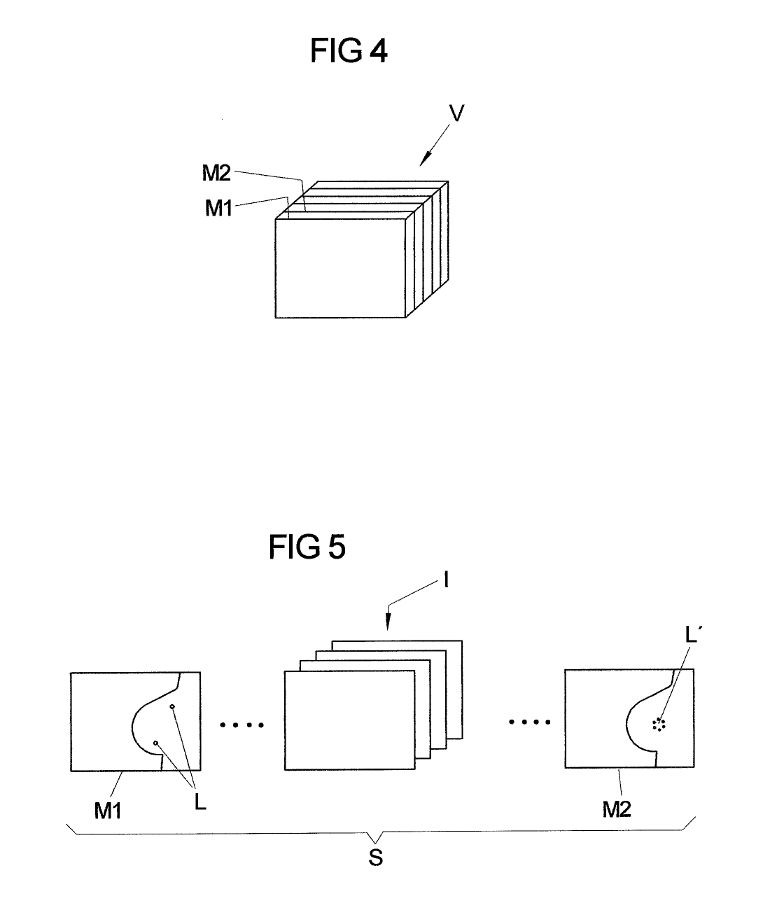

For example, as schematically shown in FIG. 4, by means of the so called digital breast tomosynthesis (DBT) a three-dimensional imaging volume V can be imaged using a low dose short X-Ray sweep around a compressed breast by means of an adequate X-Ray imaging apparatus and reconstructing a three-dimensional representation of the entire breast by electronically processing the acquired projection images. In this case, a first radiological image M1 may correspond to a first slab of a stack of slabs of the three-dimensional imaging volume V, and a second radiological image M2 may correspond to an adjacent slab.

As schematically depicted in FIG. 5, also for such kind of radiological images M1, M2 a series of intermediate images I may be computed as lineal combinations of the radiological images M1, M2, hence providing a sequence of images S which can be displayed as a cinematic transition from the one radiological image M1, M2 to the other radiological image M2, M1. Hence, in a cinematic movie-like sequence the transition between the radiological images M1, M2 and hence between adjacent slabs can be visualized, allowing for an easy association of structures L, L′ between the different slabs.

With the scheme described herein, not only a transition between two radiological images M1, M2, but between more than two radiological images M1, M2 can be visualized. For this, intermediate images I between pairs of radiological images M1, M2 (corresponding to for example adjacent slabs of the three-dimensional imaging volume V) are generated to obtain sequences of images S which then can be concatenated to form a single transitional sequence between the multiple radiological images M1, M2. In this way, for example a cinematic sequence for radiological images M1, M2 of an entire three-dimensional imaging volume V within the digital breast tomosynthesis can be generated.

In principle, a procedure as described herein can be applied also to other kinds of radiological images which are available as co-registered images. For example, a first radiological image M1 may result from a mammogram which is image-processed in a first fashion, and a second radiological image M2 may result from the same mammogram being image-processed in another way. By applying a cross-fading scheme as described herein, the differently processed images can then be set in correspondence to each other in an easy, intuitive manner by providing a cross-fading sequence between the two images which can be viewed in a movie-like fashion.

The idea underlying the invention is not limited to the embodiments described herein. Rather, entirely different embodiments are conceivable making use of the described inventive concept and relating for example to entirely different medical imaging techniques.

What is claimed is:

1. A method for viewing radiological images, the method comprising:
providing a first radiological image;
providing a second radiological image co-registered with the first radiological image;
computing at least one intermediate image as an interpolation of the first radiological image and the second radiological image; and
displaying a sequence of images comprising the first radiological image, at least one intermediate image, and the second radiological image.

2. The method according to claim 1, wherein the first radiological image is a recombined contrast enhanced spectral mammography image and the second radiological image is a low-energy contrast-enhanced spectral mammography image.

3. The method according to claim 1, wherein the first radiological image and the second radiological image are different images of a three-dimensional imaging volume.

4. The method according to claim 3, wherein the first radiological image and the second radiological image are digital breast tomosynthesis images.

5. The method according to claim 1, wherein the first radiological image and the second radiological image are images obtained from a different image processing of a mammogram.

6. The method according to claim 1, wherein the interpolation is computed by linear combination of the first radiological image and the second radiological image.

7. The method according to claim 6, wherein the first radiological image is a recombined contrast enhanced spectral mammography image and the second radiological image is a low-energy contrast-enhanced spectral mammography image.

8. The method according to claim 6, wherein the interpolation is computed as a content dependent transition.

9. The method according to claim 8, wherein the interpolation is computed based on specific regions or structures contained in at least one of the first radiological image and the second radiological image or based on a local intensity value of at least one of the first radiological image and the second radiological image.

10. The method according to claim 1, wherein the interpolation is computed as a content dependent transition.

11. The method according to claim 10, wherein the interpolation is computed based on specific regions or structures contained in at least one of the first radiological image and the second radiological image or based on a local intensity value of at least one of the first radiological image and the second radiological image.

12. The method according to claim 11, wherein the first radiological image is a recombined contrast enhanced spectral mammography image and the second radiological image is a low-energy contrast-enhanced spectral mammography image.

13. The method according to claim 1, wherein that the at least one intermediate image is computed upon a viewing request by a user.

14. The method according to claim 1, wherein the at least one intermediate image is pre-computed prior to a viewing request by a user.

15. The method according to claim 1, wherein sequences of images are concatenated in case more than two radiological images are provided.

16. The method according to claim 1, further comprising:
providing a toolbar for viewing the sequence of images is to a user if the first radiological image and the second radiological image are available for displaying; and
not providing the toolbar if at least one of the first radiological image and the second radiological image are not available.

17. The method according to claim 1, further comprising:
providing a toolbar for adjusting the speed of the displaying of the sequence of images and for allowing a forwarding, a backwarding and/or a stopping at an arbitrary point during the displaying of the sequence of images.

18. An image processing apparatus for viewing radiological images, the image processing apparatus comprising:
a processing unit; and
a display unit,
wherein the processing unit is configured to compute at least one intermediate image as an interpolation of a first radiological image and a second radiological image, the second radiological image being co-registered with the first radiological image, and the display unit is configured to display a sequence of images comprising the first radiological image, the at least one intermediate image, and the second radiological image.
